(19) United States
(12) Patent Application Publication
(10) Pub. No.: US 2013/0067235 A1
(43) Pub. Date: Mar. 14, 2013

(54) COMPUTING DEVICE FOR AUTHENTICATION

(71) Applicant: Mark ANSON, Chippendale (AU)

(72) Inventor: Mark ANSON, Chippendale (AU)

(73) Assignee: NOWWW.US PTY LTD., Chippendale (AU)

(21) Appl. No.: 13/572,184

(22) Filed: Aug. 10, 2012

(30) Foreign Application Priority Data
Aug. 11, 2011 (AU) 2011903198

(51) Int. Cl. H04L 9/32

(52) U.S. Cl. 713/186

(57) ABSTRACT

There is provided a computing device for authentication. The computing device comprises a processor for processing digital data; a memory device for storing digital data including computer program code and being coupled to the processor; and an interface for sending and receiving digital data and being coupled to the processor. The processor is controlled by the computer program code to receive, via the interface, image selection data representing an image selection from a set of candidate images; and authenticate in accordance with the image selection data.

### FIELD OF THE INVENTION

The present invention relates to a computing device for authentication.

The invention has been developed primarily for use with mobile computing devices and will be described hereinafter with reference to this application. However, it will be appreciated that the invention is not limited to this particular field of use.

BACKGROUND

Secure electronic authentication is vital in today's digital infrastructure. Secure authentication is vital for the purposes of securing electronic transactions, verifying identity, preventing fraud and the like.

Existing electronic authentication techniques usually require the use of login credentials such as a user name and secret password for the purposes of authenticating. However, these existing authentication techniques are not particularly user-friendly often requiring the user to memorise various passwords for different applications. Some users resort to writing down their login credentials which defeats the purpose of the use of a secret password.

It is to be understood that, if any prior art information is referred to herein, such reference does not constitute an admission that the information forms part of the common general knowledge in the art, in Australia or any other country.

### SUMMARY

According to one aspect of there is provided a computing device for authentication, the computing device comprising a processor for processing digital data; a memory device for storing digital data including computer program code and being coupled to the processor; and an interface for sending and receiving digital data and being coupled to the processor, wherein the processor is controlled by the computer program code to receive, via the interface, image selection data representing an image selection from a set of candidate images; authenticate in accordance with the image selection data.

Advantageously, the computing device is adapted for allowing users to authenticate and a simple, user-friendly and intuitive manner. The use of images in authentication by the computing device provides a user with more readily memorable login credentials as opposed to conventional passwords and the like while providing similar levels of security.

Preferably, in authenticating, the processor is further controlled by the computer program code to compare the image selection data against authentication image data representing an authentication image.

Advantageously, the computing device is adapted for determining whether an image selected by a user matches an authentication or password image. If so, the computing device is adapted for authenticating the user.

Preferably the processor is further controlled by the computer program code to calculate session data representing a session, and associate the authentication image data with the session data.

Advantageously, the computing device is adapted for providing the authentication image with finite lifespan, during which it may be used for the purposes authentication. At the expiration of the session, another authentication image is selected by the computing device, or alternatively, the computing device falls back to conventional login credential authentication.

Preferably the processor is further controlled by the computer program code to receive, via the interface, credential data representing login credentials; and calculate the session data in accordance with the login credentials.

Advantageously, the computing device is adapted for allowing a user to login with conventional login credentials, whereafter, for a certain period after having login with the conventional login credentials, the computing device is adapted for allowing the user to login in the simpler and more efficient image authentication manner.

Preferably the processor is further controlled by the computer program code to select candidates image data representing the set of candidate images from superset image data representing a superset of images.

Preferably the candidate image data is selected in a pseudorandom manner.

Advantageously, the computing device is adapted for selecting randomised images for the selection of the authentication image, reducing the possibility of unauthorised authentication.

Preferably the processor is further controlled by the computer program code to receive, via the interface, further image selection data representing a further image selection from the set of images; and authenticate further in accordance with the further image selection data.

Advantageously, the computing device is adapted for employing iterative image selection for the purposes of decreasing the probability of unauthorised authentication.

Preferably the processor is further controlled by the computer program code to calculate session data representing a session, and authenticate further in accordance with the session data.

Advantageously, the computing device is adapted for employing tiered authentication by allowing a user to perform a first image authentication at a first offence, and within a certain time period performing a subsequent image authentication. By spacing apart in time the first and the second image authentication, the computing device substantially prevents the probability of eavesdropping.

Preferably the processor is further controlled by the computer program code to receive, via the interface, zone association data representing an association of the image selection with a zone; and authenticate further in accordance with the zone association data.

Advantageously, the computing device is adapted for decreasing the probability of unauthorised authentication by further requiring the user to associate a selected image with a certain zone.

Preferably the processor is further controlled by the computer program code to recognise a gesture.

Preferably the gesture is a drag and drop gesture.

Preferably the gesture is a swipe gesture.

Advantageously, the computing device is adapted for recognising various gestures for selecting the image and associating the image with a zone.

Preferably the computing device further comprises a display device for displaying information, the display device being coupled to the processor, and wherein the processor is further controlled by the computer program code to display, using the display device, the set of candidate images.

Preferably, the processor is further controlled by the computer program code to display, using the display device, the set of candidate images in grid format.

Preferably, the processor is further controlled by the computer program code to display, using the display device, the set of candidate images in pseudorandom order.

Advantageously, by displaying the set of candidate images in pseudorandom order, the computing device is adapted for substantially reducing the possibility of gesture emulation by an eavesdropper.

Preferably, the processor is further controlled by the computer program code to display, using the display device, a set of zones.

Preferably, the processor is further controlled by the computer program code to display, using the display device, the set of zones pheripheral the candidate images.

According to another aspect, there is provided a computing device for authentication, the computing device comprising a processor for processing digital data; a memory device for storing digital data including computer program code and being coupled to the processor; and an interface for sending and receiving digital data and being coupled to the processor, wherein the processor is controlled by the computer program code to receive, via the interface, image selection data representing an image selection from a set of candidate images; select authentication image data representing an authentication image in accordance with session data representing a session; and authenticate in accordance with a comparison of the image selection data and the authentication image data.

Advantageously, the computing device is adapted for allowing authentication by the selection of a specific image within a certain time period as represented by a session.

Other aspects of the invention are also disclosed.

### BRIEF DESCRIPTION OF THE DRAWINGS

Notwithstanding any other forms which may fall within the scope of the present invention, preferred embodiments of the invention will now be described, by way of example only, with reference to the accompanying drawings in which:

FIG. 1 shows a computing device on which the various embodiments described herein may be implemented in accordance with an embodiment of the present invention;

FIG. 2 shows a network of computing devices on which the various embodiments described herein may be implemented in accordance with an embodiment of the present invention;

FIG. 3 shows a computer implemented method for facilitating a financial transaction between a vendor and a customer in accordance with a preferred embodiment of the present invention;

FIG. 4 shows exemplary screenshots of mobile computing device adapted to use financial transaction identification barcode image data for facilitating a financial transaction in accordance with a preferred embodiment of the present invention;

FIG. 5 shows an exemplary screenshots and arrangements of the mobile computing device of FIG. 4 adapted to receive product barcode scan data in accordance with an embodiment of the present invention; and

FIGS. 6 to 17 show exemplary screenshots and arrangements of mobile computing devices adapted to use customer identification barcode image data for facilitating a financial transaction and authentication in accordance with a preferred embodiment of the present invention; and

FIG. 7 shows an exemplary graphical user interface comprising a set of candidate images for selection in authentication in accordance with a preferred embodiment of the present invention.

### DETAILED DESCRIPTION OF SPECIFIC EMBODIMENTS

It should be noted in the following description that like or the same reference numerals in different embodiments denote the same or similar features.

Computing Device

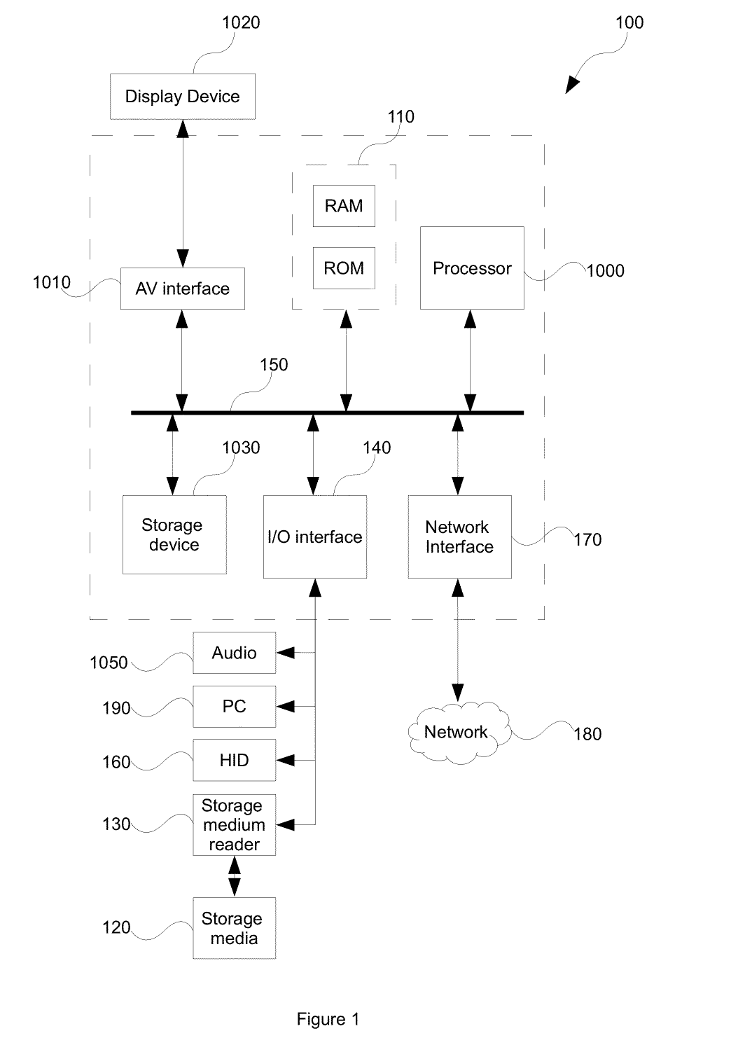

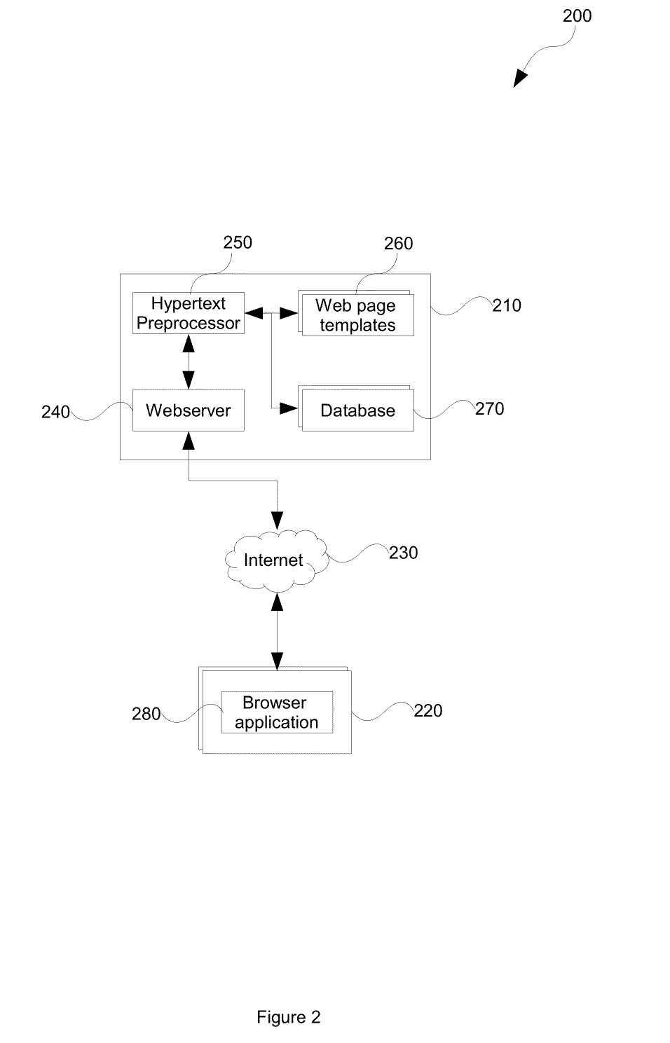

FIG. 1 shows a computing device 100 on which the various embodiments described herein may be implemented. In particular the steps of the methods of facilitating a financial transaction between a vendor and a customer and authenticating using image selections as described in further detail below may be implemented as computer program code instructions executable by the computing device 100. The computer program code instructions may be divided into one or more computer program code instruction libraries, such as dynamic link libraries (DLL), wherein each of the libraries performs a one or more steps of the method. Additionally, a subset of the one or more of the libraries may perform graphical user interface tasks relating to the steps of the method.

The device 100 comprises semiconductor memory 110 comprising volatile memory such as random access memory (RAM) or read only memory (ROM). The memory 100 may comprise either RAM or ROM or a combination of RAM and ROM.

The device 100 comprises a computer program code storage medium reader 130 for reading the computer program code instructions from computer program code storage media 120. The storage media 120 may be optical media such as CD-ROM disks, magnetic media such as floppy disks and tape cassettes or flash media such as USB memory sticks.

The device further comprises I/O interface 140 for communicating with one or more peripheral devices. The I/O interface 140 may offer both serial and parallel interface connectivity. For example, the I/O interface 140 may comprise a Small Computer System Interface (SCSI), Universal Serial Bus (USB) or similar I/O interface for interfacing with the storage medium reader 130. The I/O interface 140 may also communicate with one or more human input devices (HID) 160 such as keyboards, pointing devices, joysticks and the like. The I/O interface 140 may also comprise a computer to computer interface, such as a Recommended Standard 232 (RS-232) interface, for interfacing the device 100 with one or more personal computer (PC) devices 190. The I/O interface 140 may also comprise an audio interface for communicate audio signals to one or more audio devices 1050, such as a speaker or a buzzer.

The device 100 also comprises a network interface 170 for communicating with one or more computer networks 180. The network 180 may be a wired network, such as a wired Ethernet™ network or a wireless network, such as a Bluetooth™ network or IEEE 802.11 network. The network 180 may be a local area network (LAN), such as a home or office computer network, or a wide area network (WAN), such as the Internet or private WAN.

The device 100 comprises an arithmetic logic unit or processor 1000 for performing the computer program code instructions. The processor 1000 may be a reduced instruction set computer (RISC) or complex instruction set computer (CISC) processor or the like. The device 100 further comprises a storage device 1030, such as a magnetic disk hard drive or a solid state disk drive.

Computer program code instructions may be loaded into the storage device 1030 from the storage media 120 using the storage medium reader 130 or from the network 180 using network interface 170. During the bootstrap phase, an operating system and one or more software applications are loaded from the storage device 1030 into the memory 110. During the fetch-decode-execute cycle, the processor 1000 fetches computer program code instructions from memory 110, decodes the instructions into machine code, executes the instructions and stores one or more intermediate results in memory 100.

In this manner, the instructions stored in the memory 110, when retrieved and executed by the processor 1000, may configure the computing device 100 as a special-purpose machine that may perform the functions described herein.

The device 100 also comprises a video interface 1010 for conveying video signals to a display device 1020, such as a liquid crystal display (LCD), cathode-ray tube (CRT) or similar display device.

The device 100 also comprises a communication bus subsystem 150 for interconnecting the various devices described above. The bus subsystem 150 may offer parallel connectivity such as Industry Standard Architecture (ISA), conventional Peripheral Component protocols and may be coupled across a variety of wireless and wired networks including Asynchronous Transfer Mode (ATM), Integrated Services Digital Network (ISDN), GSM (Global System for Mobile Communications) and General packet radio service (GPRS) networks.

Furthermore while a vendor and a customer is used herein as an exemplary description of the parties to the financial transaction, such as a sale or lease financial transaction, certain embodiments may be used to facilitate other types of financial transactions, such as, for example, financial transaction relating to the fund transfer, escrow and the like.

As will be described in further detail below, the method 300 comprises step 315 wherein the web server 210 is adapted for receiving barcode scan data from a mobile device and step 320 wherein the web server 210 is adapted for facilitating the financial transaction in accordance with the barcode scan data. In certain embodiments, the web server 210 is adapted for receiving barcode scan data from other devices, such as non-mobile devices, including cash registers, automatic teller machines and the like.

The web server 210 is adapted for facilitating the financial transaction depending on the application. Specifically, in a first embodiment for facilitating the financial transaction, the web server 210, in facilitating the financial transaction in accordance with the barcode scan data is adapted for generating invoice data in accordance with the barcode scan data. In this manner, the invoice data may be made available to the customer and/or the vendor such that the customer and the vendor may complete the financial transaction in the usual manner.

According to a second embodiment for facilitating the financial transaction, the web server 210, in facilitating the financial transaction in accordance with the barcode scan data, is adapted for initiating an electronic funds transfer in accordance with the barcode scan data. In this manner, the web server 210 is adapted for conducting a real-time financial transaction between the vendor and the customer.

Preferably, the web server 210, in initiating an electronic funds transfer in accordance with the financial transaction data, is adapted for initiating an electronic funds transfer using a third party electronic funds transfer gateway. For example, the web server may be securely coupled to a financial institution, such as a bank. In this manner, the web server 210, having authenticated with the financial institution, is adapted for issuing financial transaction authorization instructions to the financial institution.

In a third embodiment for facilitating the financial transaction, the web server 210, in facilitating the financial transaction in accordance with the barcode scan data is adapted for generating receipt data in accordance with the barcode scan data. In this manner, the receipt data may be made available to the customer or the vendor.

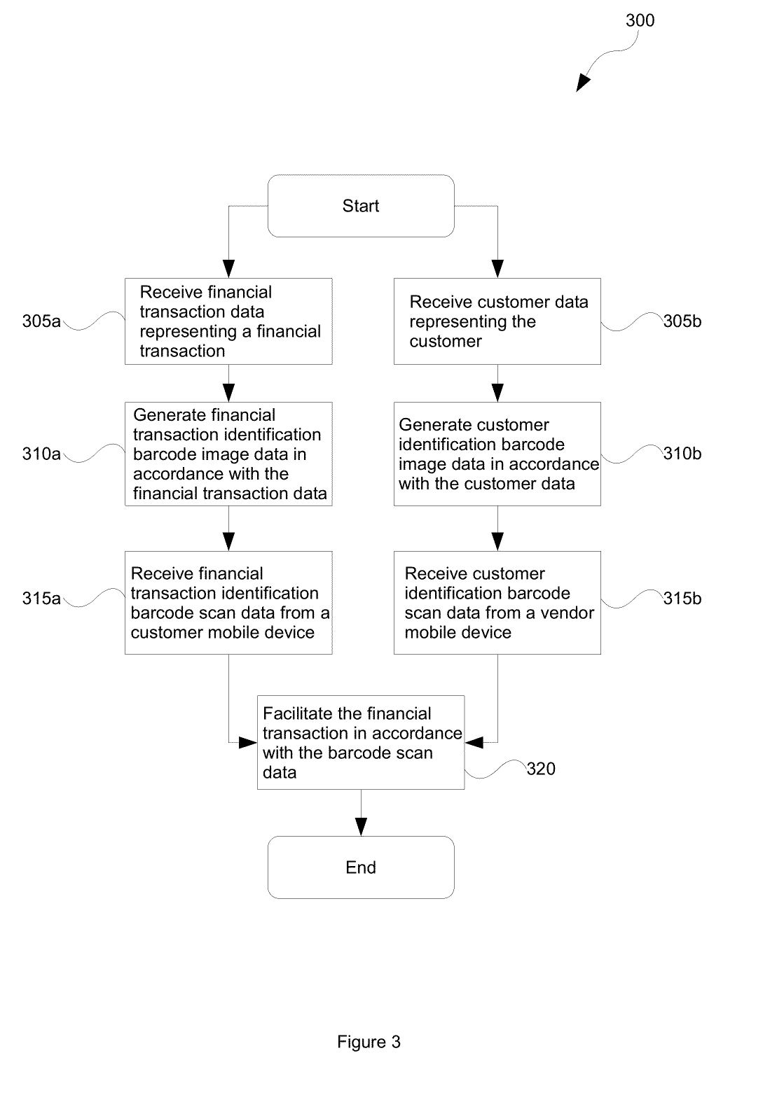

In a first preferred embodiment, the web server 210 is adapted for facilitating the financial transaction in accordance with financial transaction data received from the customer or the vendor. This first preferred embodiment is exemplified by the left hand branch of method 300 comprising numerals ending in ‘a’ as shown in FIG. 3.

Specifically, at step 305a the web server 210 is adapted for receiving financial transaction data representing a financial transaction and step 310a the web server 210 is adapted for generating financial transaction identification barcode image data in accordance with the financial transaction data.

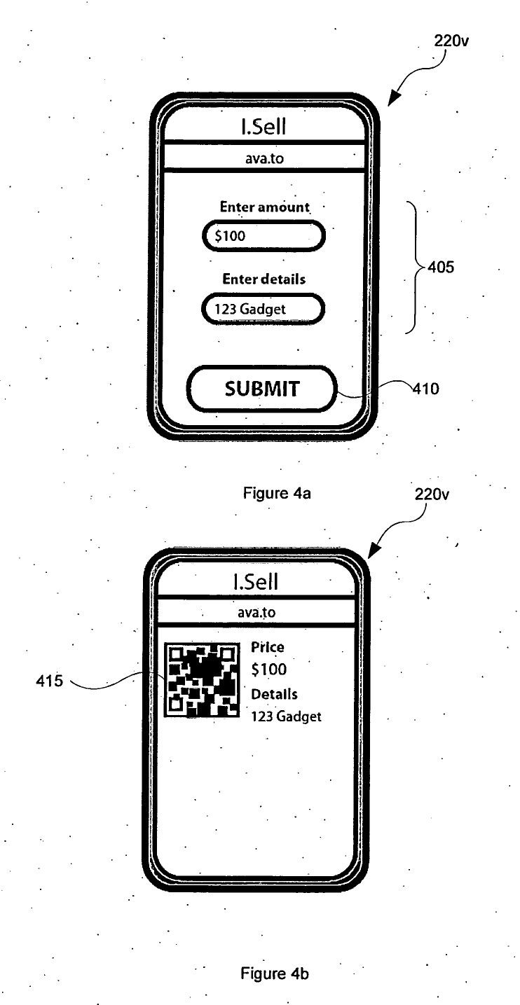

FIG. 4 shows exemplary screenshots of a client computing device and in particular a vendor mobile computing device 220v in accordance with the first preferred embodiment.

The vendor mobile computing device 220v comprises a graphical user interface (GUI) for receiving financial transaction data representing a financial transaction and generating financial transaction identification barcode image data in accordance with the financial transaction data. Specifically, the GUI comprises input means 405 for inputting financial transaction data. In the example given, the vendor is vending a ‘123 gadget’ for $100. The GUI further comprises a submit button 410 for sending the financial transaction data to the web server 210. Upon receipt of the financial transaction data, the web server 210 is adapted for storing the financial transaction data in the database. In one embodiment, the web server 210 is adapted for generating a unique transaction id, such as a database auto increment primary key, associated with the financial transaction data.

At step 310a the web server 210 is further adapted for generating QR barcode data 415 encoding the unique transaction id for the financial transaction data. In one example, the unique transaction id (txnid) may be encoded as a uniform resource locator (URL), such as:
http://www.ava.to/?txn_id=87623&auth=109DN3

It should be noted that other types of graphically representable data suitable for scanning may be used instead of QR barcode data. The web server 210 is adapted for sending the QR barcode data 415 to the vendor mobile computing device 220v for display, as is shown in exemplary FIG. 4b.

At step 315a, the web server 210, in receiving barcode scan data from a mobile device is adapted for receiving financial transaction identification barcode scan data from a customer mobile device. For example, using the example given in FIG. 4, the customer, wishing to buy the 123 gadget, will scan the QR barcode data 415 displayed on the vendor mobile computing device 220v using a customer mobile computing device. The customer mobile computing device may be provided with barcode reading application software to facilitate this process. The customer mobile computing device is adapted for sending the financial transaction identification barcode scan data to the web server 210.

In certain embodiments, the QR barcode data 415 need not be displayed on a vendor mobile computing device 220v. For example, the QR barcode data 415 may be displayed in a shopping catalogue. In this manner, a customer, using a customer mobile computing device 220c may scan the QR barcode data 415 in the catalogue to order the 123 gadget.

In the example provided above wherein the unique transaction id may be encoded as a uniform resource locator, the customer mobile computing device 220c may be adapted to browse to the uniform resource locator. In this manner, the web server 210 may be adapted to facilitate the financial transaction data as a normal HTTP or HTTPS request.

The customer may be prompted by the customer mobile computing device 220c for inputting authentication data such as pin data before the customer mobile computing device sends the financial transaction identification barcode scan data to the web server 210.

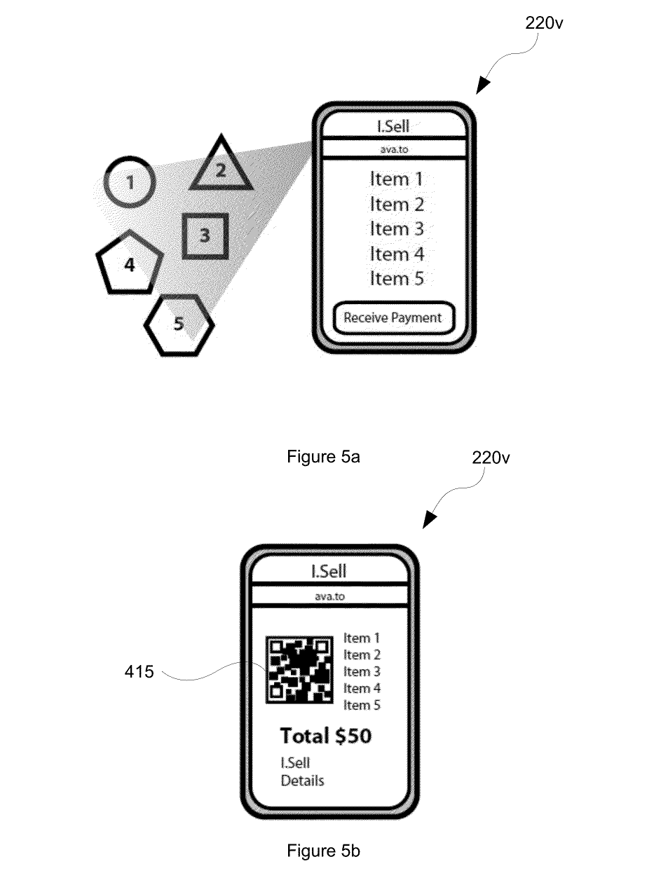

In one embodiment, as exemplified in FIG. 5, instead of the vendor having to input financial transaction data using the GUI displayed on the vendor mobile computing device 220v, the vendor mobile computing device 220v may is adapted to receive product barcode scan data from the vendor mobile computing device 220v. In this manner, the vendor may scan the barcodes as appearing on one or more products. The vendor mobile computing device 220v may comprise a database for resolving the product barcode scan data into financial transaction data. Alternatively, web server 210 database 270 may comprise data for resolving the product barcode scan data into financial transaction data

In a second preferred embodiment, the web server 210 is adapted for facilitating the financial transaction in accordance with customer data received from the customer or the vendor. This second preferred embodiment is exemplified by the right hand branch of method 300 comprising numerals ending in ‘b’ as shown in FIG. 3. This second preferred embodiment may be adapted for facilitating ‘micro-transactions’ wherein a customer buys one or more low value items, such as cups of coffee and the like.

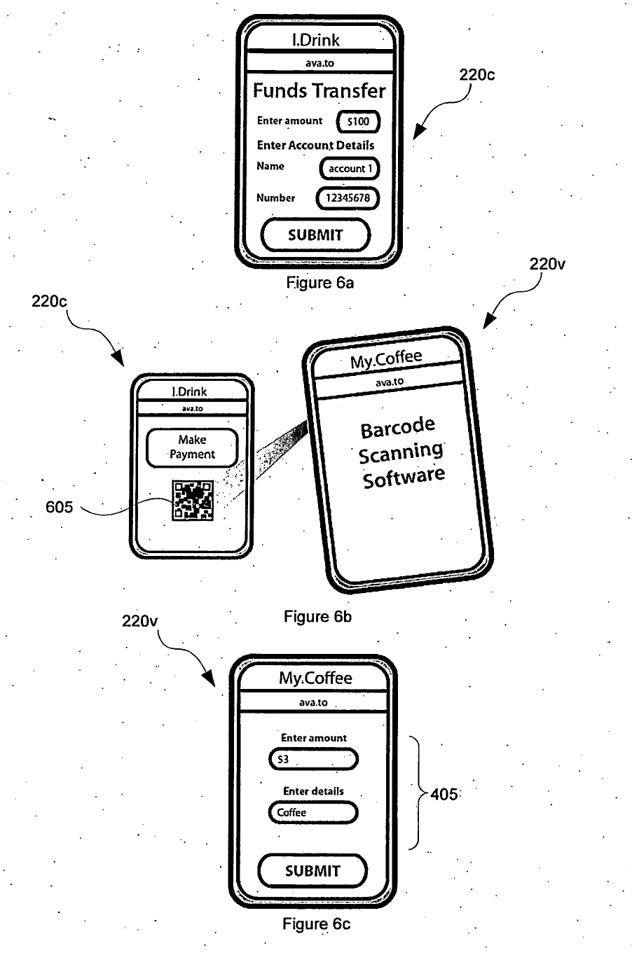

Specifically, in this second preferred embodiment, the method comprises step 305b wherein the web server 210 is adapted for receiving customer data representing the customer. An example of this second preferred embodiment is given in FIG. 6, wherein a customer buying coffee from a coffee vendor is used as an example.

As is shown in FIG. 6a, a customer is able to set up an account with the web server 210 including transferring funds for providing an account balance associated with the account.

At step 310b, the web server 210 is adapted for generating customer identification barcode image data 605 in accordance with the customer data. In the example given, the customer identification barcode image data 605 is QR barcode image data. For example, each customer may be associated with a unique customer id, such as an auto increment primary key from a customer table in the database 270. In one example, the unique customer id (cust_id) may be encoded within the QR barcode image data as a uniform resource locator (URL), such as:
http://www.ava.to/?cust_id=41361

As such, when the customer wishes to make a purchase, the web server 210 is adapted for sending the QR barcode data 605 to the customer mobile computing device 220c for display, as is shown in exemplary FIG. 6b.

Once the customer QR barcode data 605 representing the customer is displayed on the customer mobile computing device 220c, the vendor may scan the customer QR barcode data 605 using the vendor mobile computing device 220v. As such, the web server 210, in receiving barcode scan data from a mobile device, is adapted for receiving customer identification barcode scan data from the vendor mobile computing device 220v. In this manner, the web server 210, when facilitating the financial transaction in accordance with the barcode scan data, is be adapted for identifying the customer in accordance with the customer identification barcode scan data.

As is shown in FIG. 6c, the vendor mobile computing device 220v comprises a GUI comprising financial transaction data input means 405 for inputting financial transaction data. In this example, the vendor has input that a cup of coffee is being sold for $3. In this manner, the customer identification barcode scan data and financial transaction data is sent to the web server 210 such that the web server 210 is able to process the sale of the cup of coffee.

In one particular embodiment, the web server 210 may, in receiving barcode scan data from a mobile device, be adapted for receiving customer identification barcode scan data from the customer mobile computing device 220c and authenticating the customer mobile computing device 220c in accordance with the customer identification barcode scan data.

For example, a company may be provided with one or more public barcodes by a financial institution. The company may then provide a public barcode to one or more employees of the company for the purpose of performing financial transactions on behalf of the company.

Specifically, the company may provide a public barcode to an employee. The employee, using the customer mobile computing device 220c may scan the public barcode, for example by scanning the public barcode displayed on a display device 1020 or printing out the public barcode and scanning the hard copy of the public barcode. In this manner, the customer mobile computing device 220c is adapted for sending public barcode scan data to the web server 210. The employee may additionally be required to enter in other authentication data, such as pin data. The web server 210 will check that the public barcode scan data matches one or more public barcodes issued to the company. If a match is found, then the web server 210 authenticates the customer mobile computing device 220c such that the employee is then able to make purchases on the company account using the authenticated customer mobile computing device 220c. The authentication may be a permanent authentication wherein, for example an authenticated flag is set within a configuration file of the customer mobile computing device 220c. Alternatively, the authentication may be temporary, wherein, for example the web server 210 uses session management means such as cookies to authenticate the customer mobile computing device 220c for a certain period. In this manner, the employee may be required to authenticate the customer mobile computing device 220c each time a purchase is made after a certain time period.

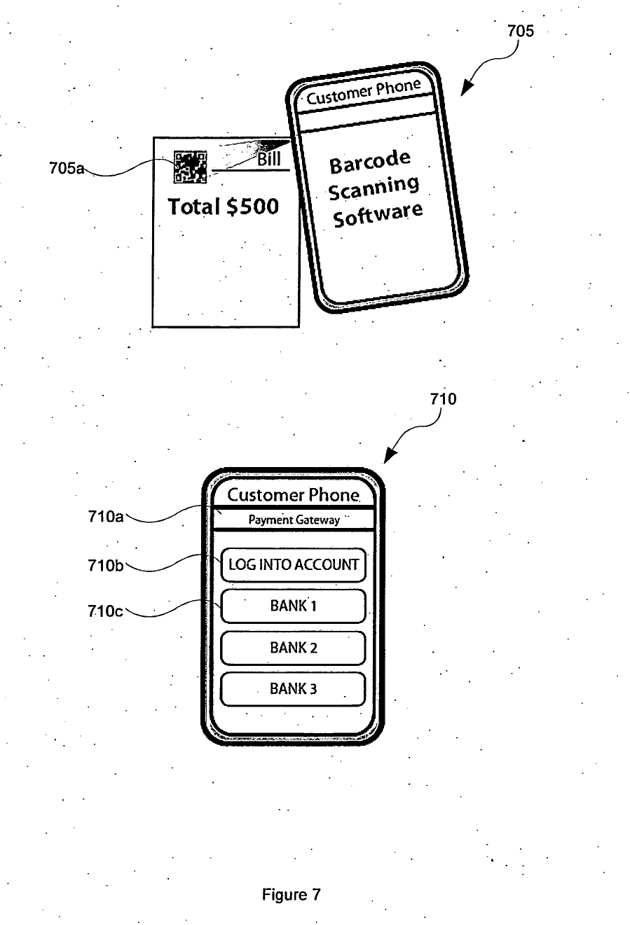

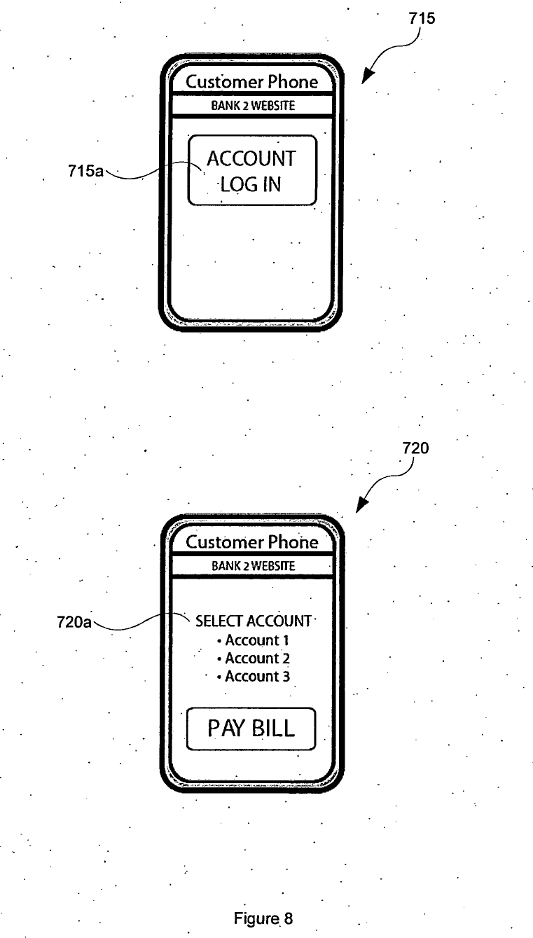

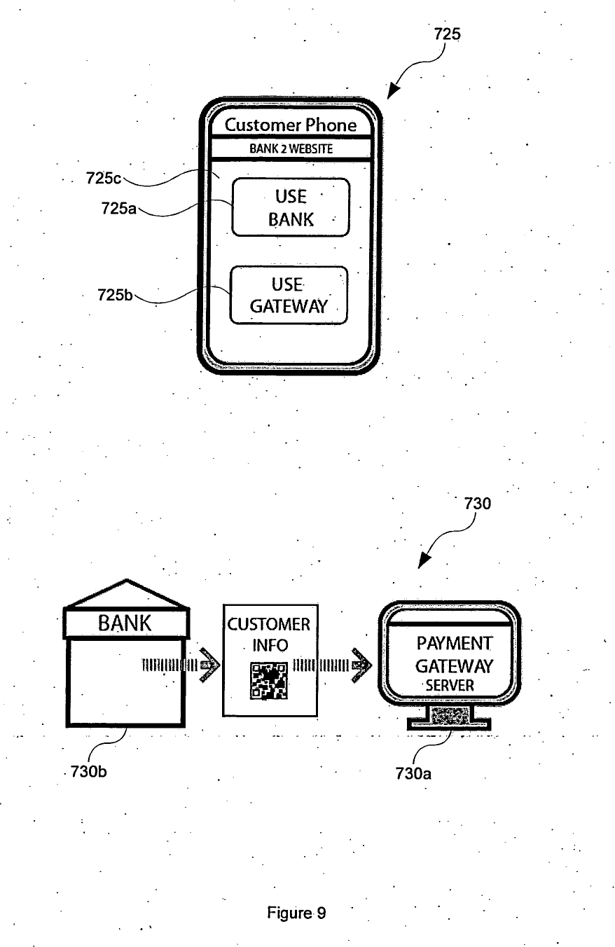

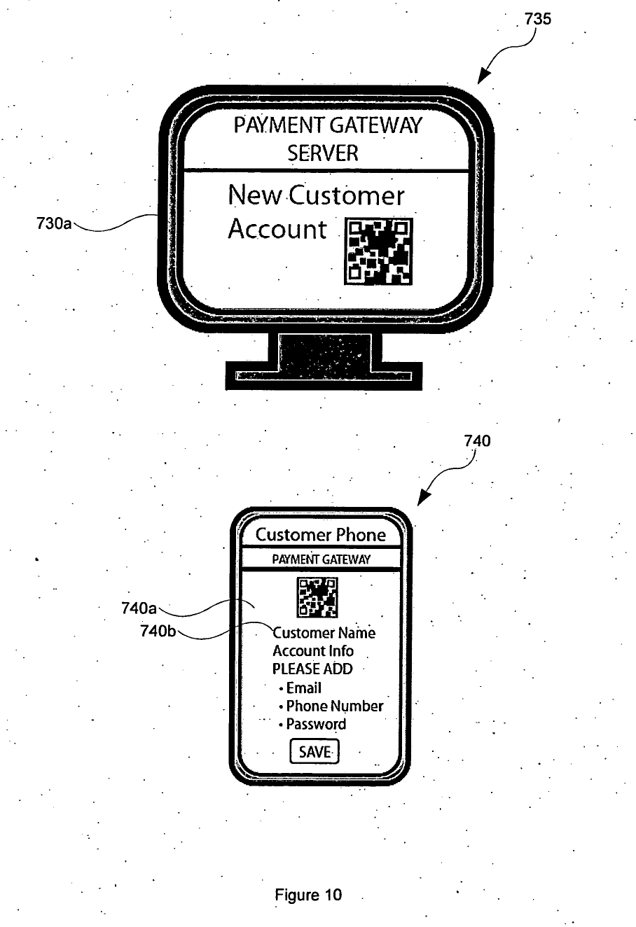

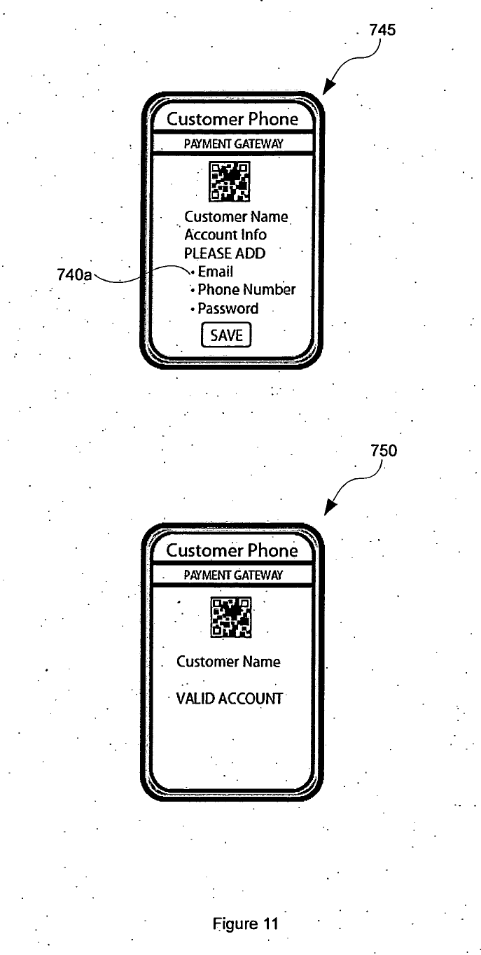

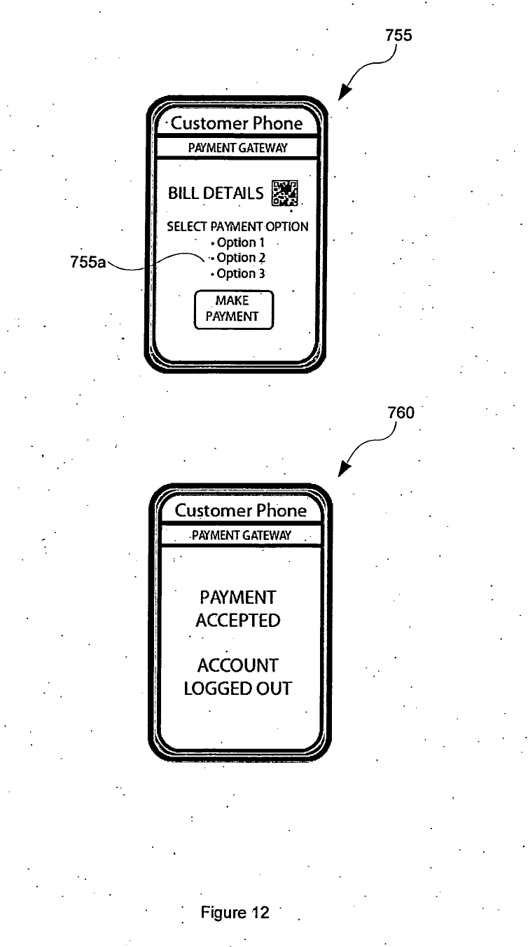

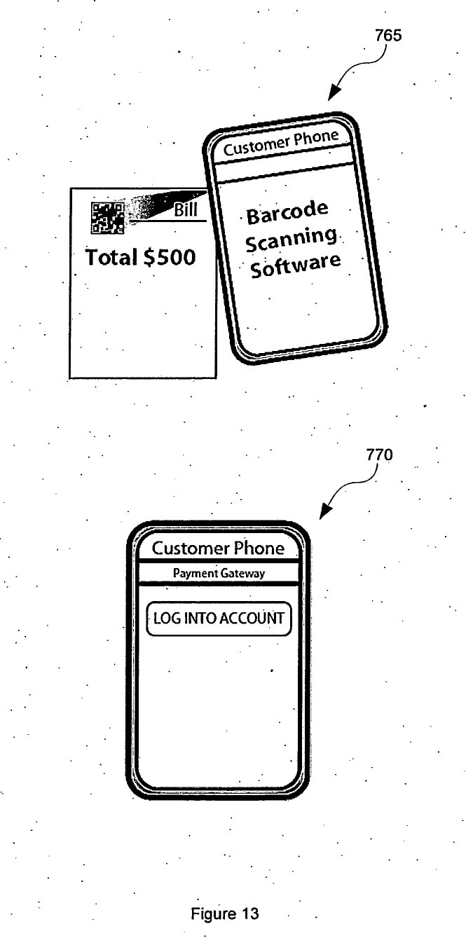

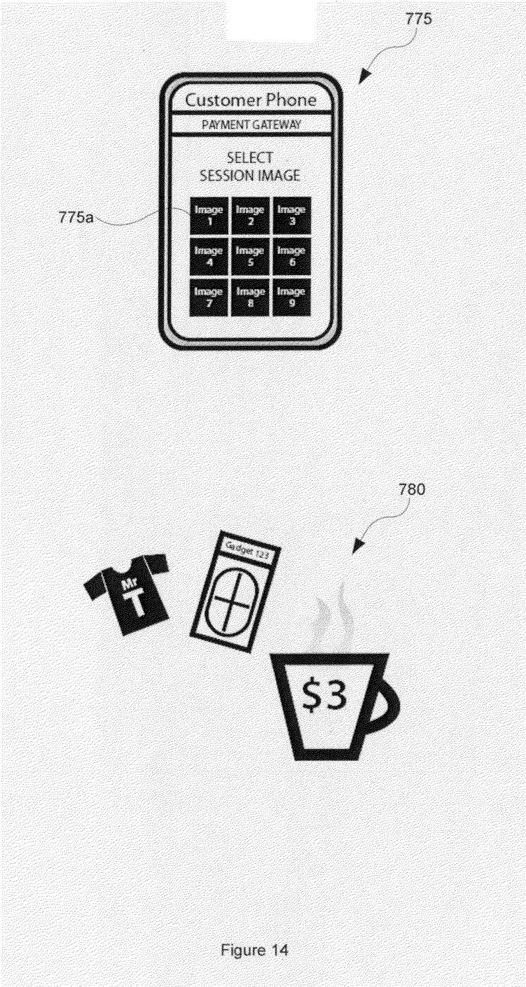

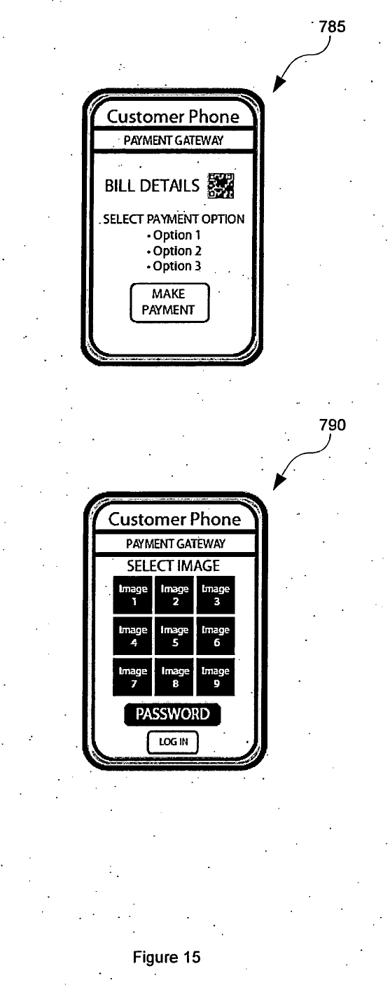

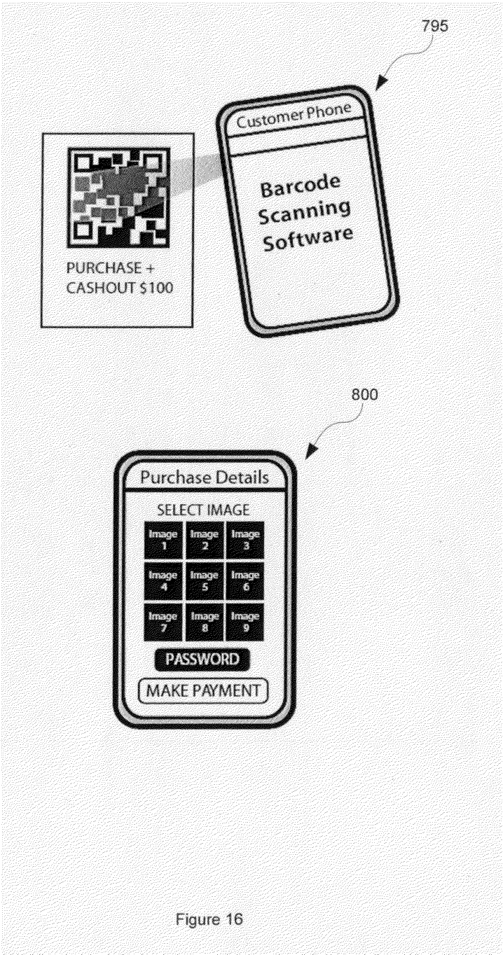

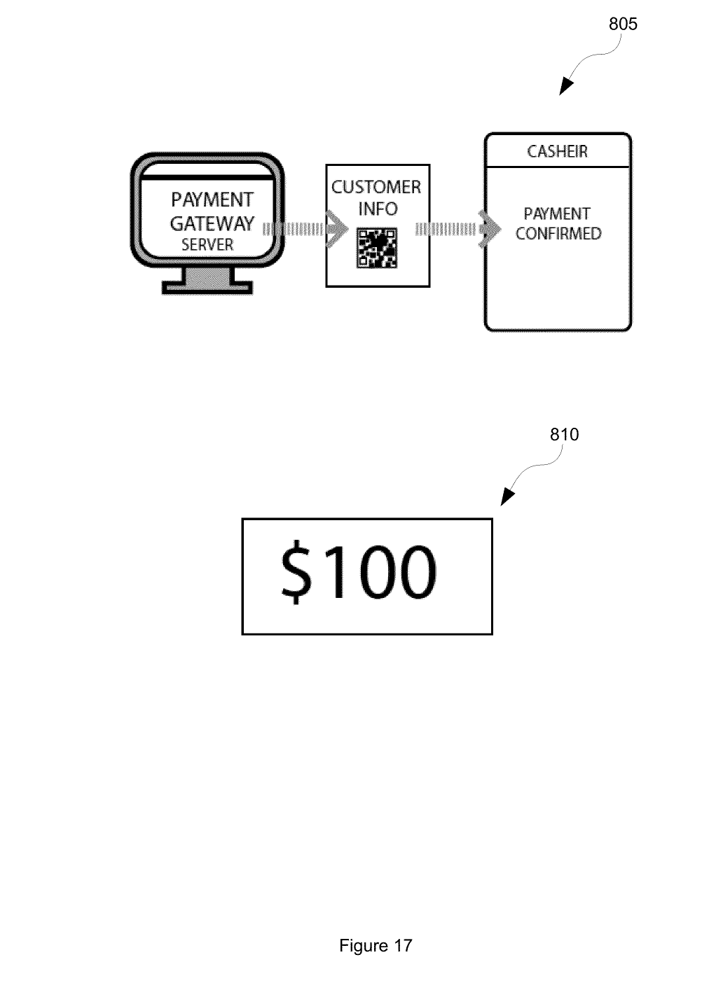

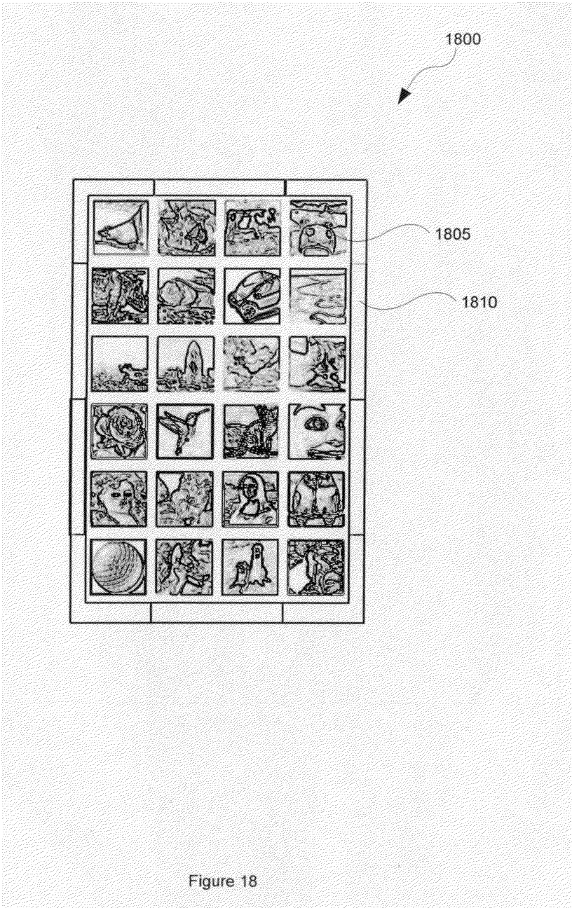

The above and other features of the various embodiments described herein will now be described by way of a user case example with reference to FIGS. 7 to 17.

The user case example starts at step 705, where a customer receives a utility bill comprising a QR barcode 705a. As was mentioned above, the barcode need not necessarily be a QR barcode, and may take the form of a standard 1D barcode and the like. In one embodiment, the barcode 705a represents the bill for $500 and may comprise URL data indicating a resource related to the bill for $500.

In other embodiments however, the barcode 705a may relate to other information, such as a customer account. In this manner, the barcode 705a may encode URL data indicating a resource related to the utility account for the customer. In this manner, the resource related to the utility account for the customer may be operable to select only the outstanding bills for the customer.

Note that in other embodiments the barcode 705a need not necessarily relate to the payment of utilities, and may relate to other expenditure as required.

Using the customer mobile computing device 220c, the customer scans the barcode 705a.

At step 710, where the barcode 705a encodes URL data, the barcode 705a may cause the customer mobile computing device 220c to browse to a payment gateway resource 710a.

The customer mobile computing device 220c may browse to the payment gateway by other means, such as an application running on the customer mobile computing device 220c that causes the customer mobile computing device 220c to display the payment gateway resource 710a.

In the embodiment shown in step 710, the payment gateway 710a displays a number of options, including an option 710b to log using the payment gateway and an option 710c to log in using a bank in order to effect the payment.

At step 715, where the customer chooses to log into a bank using option 710c, the customer mobile computing device 220c browses to a bank login interface 715a. Again, the bank login interface 715a may be an interface generated by a web browser, an interface generated by a mobile application and the like.

At step 720, once the customer has logged in using the bank login interface 715a, the customer mobile computing device 220c is operable to display an account selection and payment interface 720a. In one embodiment, the account selection and payment interface 720a is adapted in accordance with the type and amount of the transaction. For example the account selection and payment interface 720a may be operable to display the amount to be paid as confirmation.

In one embodiment, the banking institution system associated with the account selection and payment interface 720a may receive data representing the type and amount of the transaction from the barcode image data wherein the barcode image data encodes such information. In another embodiment, the banking institution system associated with the account selection and payment interface 720a may receive data representing the type and amount of the transaction from the HTTP or HTTPS request by means of GET and POST requests as required. In a further embodiment, for security, the banking institution system may be operable to look up the data representing the type and amount of the transaction using a secure gateway associated with the issuer of the barcode 705a.

At step 725, having received a selection of an account, the customer mobile computing device 220c is operable to display a payment gateway selection interface 725c comprising at least a first option 725a to pay using the banking institution and a second option 725b to pay using a payment gateway. The payment gateway may be a third party gateway operated by a payment gateway provider for facilitating financial transactions originating from a number of sources in the manner as further described below.

If the customer chooses to pay using the banking institution, the banking institution facilitates payment of the bill indicated by the barcode 705a. As was mentioned above, the banking system may be operable to fetch ancillary information related to the barcode 705a for facilitating the payment, such as from secure web service having a function that has as input a barcode ID and outputs the recipient bank account details, the amount of the transaction and the like. In an alternative embodiment, the ancillary information may be encoded in the barcode 705a. In this manner, where the barcode 705a encodes a URL, the ancillary information may be contained as GET variables in the URL, or sent via a POST request by the customer mobile computing device 220c.

At step 720, should the customer select second option 725b to pay using the payment gateway a message is sent to the payment gateway server 730a by the banking institution 730b containing data relating to the transaction. In various embodiments, the message may comprise various data relating to the transaction as required, including customer data as follows:
details of the customer, such as customer ID, bank account number, BSB and other information, sent via GET or POST request in one embodiment;
a barcode ID, wherein the payment gateway is operable to fetch customer data from a web service using the barcode ID; and
the barcode image data, wherein the barcode 705a is encoded with the customer ID, bank account number, BSB and other information.

In another embodiment, the message is sent directly from the mobile computing device 220c to the payment gateway server 730a.

At step 735, upon receipt of the above data, the payment gateway server 730a is operable to set up a new account for the customer if the customer is a new customer, or identify an existing customer account if the customer is a returning customer.

At step 740, the customer mobile computing device 220c is operable to display a payment gateway interface 740a. Certain of the information conveyed by the payment gateway interface 740a is pre-populated information, while at step 745 the customer is required to enter in any missing information, such as email address, phone number, password and the like.

At step 750 the payment gateway server 730a is operable to associate the customer information with the customer account.

At step 755, the customer mobile computing device 220c is operable to display details of the bill to the customer along with payment options 755a, including options such as partial payment, delay of payment, schedule for payment and the like.

At step 760, where, for example the customer decides partial payment of the bill, the payment is processed by the payment gateway server 730a according to the business rules required for this payment. Once complete, the payment gateway server 730a logs the customer out or the elects to log out manually.

Using the above example where the customer had decided partial payment of the bill, at step 765, at a later time, the customer mobile computing device 220c is operable to allow the customer to pay the remainder of the bill by again scanning the barcode 705a. Having done so, at step 770, the payment gateway server 730a is operable to determine that the customer is a returning customer, thereby causing the customer mobile computing device 220c to display a login screen for logging on to the payment gateway.

Session Image Authentication

According to a preferred embodiment there is provided a method of authenticating using session images. As will become apparent from the disclosure herein, session image authentication may be employed in any application requiring authentication. For example, in the manner described above, session image authentication may be employed for the purposes of authenticating for performing electronic financial transactions. However, the session image authentication may be applied to other uses, such as account login procedures, including, for example where a user logs on to an online bank account or e-mail account.

Generally, session image authentication comprises two main steps which performed across a session. A session may represent the process of completing a financial transaction, authenticating with a user account and the like. Generally, the first step at a first event requires a user to select (or be given) an authentication session image. Herein, images are generally easier to remember when compared to pin codes and the like. The second step requires the user to select the previously chosen authentication session image at a second event so as to validate that the user at the first event is the same user of the user at the second event.

Note that in other embodiments, sessions need not be employed. For example, a user having a mobile computing device 100 may configure the mobile computing device 100 such that the mobile computing device 100 may only be unlocked for use by the selection of a correct authentication image. As such, a user considering the mobile computing device 100 may choose a preferred authentication image so as to be able to unlock the mobile computing device 100 later using the authentication image. Note that in one embodiment, as is further described below, additional actions may be required in addition to the selection of the correct authentication image for increased security, such as by associating the session image with a zone from a plurality of zones.

In one embodiment, session images address the problem of a user having to remember login credentials and the time taken to enter such login credentials. Conversely, by selecting a preferred authentication image, a customer is easily able to verify their identity, enabling customers to quickly log in to the payment gateway to make payments such as micro payments of low cost transactions such as a cup of coffee.

As such, at step 775, each time a customer logs in the customer is asked to select a authentication image 775a from a random group of candidate images. In this manner, the client may choose an authentication image, such as an authentication image of a green frog, such that, for later events within the session the customer may be prompted to choose the same authentication image for verification purposes, as is described in further detail below.

In various embodiments, the authentication images 775a may be selected at various events other than at login events. For example, a customer may select an authentication image 775a when deciding to make a payment, such that when transferred to another provider, such as a banking institution, the customer can be shown the same session image 775a by the banking institution for authentication.

In other embodiments, authentication images 775a may be implemented in other ways, such as a four digit code chosen by a customer, a touch screen gesture and the like.

Note that at step 780, the payment gateway allows customers to pay for products and services of various kinds. An example would be that the customer might wish to pay for a coffee through the payment gateway.

In a working example comprising session images 775a, at step 785, after having selecting an authentication image 775a at step 790, the customer is shown the details of the bill and related payment options after which the customer effects the payment and logs out.

Shortly after, should the customer wish to purchase a coffee via the payment gateway at step 795 the customer scans a barcode relating to the coffee. As step 800 the customer mobile computing device 220c then browses to the payment gateway for log in and payment. At step 800, the customer may be prompted to select the same session image that was selected at step 775. The customer may additionally be presented with a password field for additional security.

In one embodiment, for more expensive payments a full log in would be required with username and password. In one embodiment, after making a payment the customer may optionally decide to list the merchant such as a supermarket as a trusted merchant such that the next time the customer makes an expensive payment at the same supermarket, for example, the customer will not have to use the extended log in.

Note that in step 795, in the process of a transaction at a supermarket the cashier may ask the customer if the customer wishes to take cash out of $100. If the customer agrees, the cashier uses their transaction device to produce a barcode comprising the purchase amount and the cash out amount.

Working example using images for authentication

A further detailed description of image authentication will now be described with reference to the exemplary graphical user interface 1800 as shown substantially in FIG. 18.

As is apparent from the embodiment shown, the interface 1800 comprises a plurality of pseudorandom candidate images 1805. The pseudorandom candidate images 1805 preferably comprise various memorable images, such as the Mona Lisa, a golf ball and the like. Note that in other embodiments, colour patches, numbers and the like may be used as opposed to images. Furthermore, the pseudorandom candidate images 1805 may be arranged in any manner as opposed to the grid format shown. However, the arrangement shown in interface 1800 comprising six rows having four candidate images 1805 each is a preferred layout as it fits the screen of most mobile computing devices available today.

The interface 1800 presents a candidate images 1805 for selection by a user. The interface 1800 further comprises a plurality of zones 1810 at the edges of the candidate images 1805. As will be described in further detail below, the computing device 100 is adapted to allow the user to associate a selected candidate image 1805 with a zone 1810 for increased security. As is apparent from the interface 1800, the interface 1800 comprises 10 zones 1810. Preferably, each zone 1810 is represented in a distinct colour, such as black, violence, blue, green, white and the like.

In a preferred embodiment, in order to authenticate with the computing device 100 successfully, the user has to know which image 1805 to touch and then slide the selected image into a correct zone. For example, in order to authenticate with the computing device 100 the user may be required to slide the session image 1805 representing the Mona Lisa into the blue zone 1810. In this manner, the probability of an unauthorised user authenticating successfully with the computing device 100 is 24×10, or, in other words, odds of 240 to 1.

In certain embodiments, additional iterations of image selection and zone association may be required for increasing security. For example, in order to authenticate, the user may be required to select the image 1805 representing the Mona Lisa, slide the Mona Lisa image 1805 into the blue zone 1810, and subsequently select a second image 1805 representing a golf ball, and the slide the golf ball image 1805 into the red zone 1810. In this manner, the mathematical probability of unauthorised authentication becomes 240×240×2 or in other words 115200 to 1.

It should be noted, that the computing device 100 may be adapted to employ various gestures including drag-and-drop, swipes, clicks and the like.

It should be noted that the image authentication process may be adapted for use on a mobile computing device such as a mobile phone for unlocking the mobile phone or for other devices, such as by using a desktop computer to authenticate with an online banking system. Where a desktop computing device is employed, the interface 1800 may be encoded in HTML comprising client side scripting, such as JavaScript, Flash and the like for the purposes of animating the session images 1805.

In a preferred embodiment, computing device 100 is adapted for arranging the locations of the session images in a pseudo random manner. In this manner, for example, were a gesture be observed, such as, for example, where a user slide in a session image from the bottom left of the screen to the top right of the screen, the rearrangement of the session images 1805 for selection in a pseudo random manner would substantially prevent an eavesdropper from emulating the gesture. Furthermore, the computing device 100 may be adapted for selecting pseudo random images 1805 for display from a larger set or superset of images.

Note that in one embodiment, the computing device 100 may be adapted to employ a two tier authentication technique. In this embodiment, a first authentication request may require a user to an input username and password credentials in a conventional manner. However, having successfully authenticated in this way, as opposed to requiring the user to an input the same credentials at each subsequent authentication, the computing device 100 may be adapted to employ session images 1805 for a specific duration, such as a day. In this manner, the user may, at a first time, such as first thing in the morning, log in with conventional credentials, where after, the computing device 100 is adapted for employing session image 1805 authentication technique for the remainder of the day.

In one embodiment, the duration for the allowance of session image 1805 authentication may depend on the above-mentioned mathematical probabilities of unauthorised access. In this manner, for simple session image 1805 authentication technique requiring, for example only one session image selection, the computing device 100 may be adapted to employ a short session, such as a session of one day. For more advanced session image 1805 authentication technique, such as for example, session image 1805 authentication technique comprising a series of session image 1805 selections and zone 1810 associations, the computing device 100 may be adapted for employing a longer session, such as a session lasting two months.

In one embodiment, the computing device 100 may be adapted for incremental authentication privileges. For example, a person looking to employ a mobile computing device 100 for performing a financial transaction at a point-of-sale device at a shop may, upon entering the shop, perform a first session image selection gesture, such as by associating a first session image 1805 with a zone 1810 so as to “check in” to the purchase process. Subsequently, such as within a time period comprising, for example 20 min, a user may authorise the financial transaction at a point-of-sale device by performing a subsequent session image selection gesture. In this manner, an eavesdropper, observing the second session image selection gesture at the point-of-sale device would be ignorant of the first session image selection gesture and therefore be unable to gain unauthorised access to computing device 100.

### Interpretation

In accordance with

As described herein, ‘in accordance with’ may also mean ‘as a function of’.

### Wireless

The invention may be embodied using devices conforming to other network standards and for other applications, including, for example other WLAN standards and other wireless standards. Applications that can be accommodated include IEEE 802.11 wireless LANs and links, and wireless Ethernet.

In the context of this document, the term “wireless” and its derivatives may be used to describe circuits, devices, systems, methods, techniques, communications channels, etc., that may communicate data through the use of modulated electromagnetic radiation through a non-solid medium. The term does not imply that the associated devices do not contain any wires, although in some embodiments they might not. In the context of this document, the term “wired” and its derivatives may be used to describe circuits, devices, systems, methods, techniques, communications channels, etc., that may communicate data through the use of modulated electromagnetic radiation through a solid medium. The term does not imply that the associated devices are coupled by electrically conductive wires.

### Processes

Unless specifically stated otherwise, as apparent from the following discussions, it is appreciated that throughout the specification discussions utilizing terms such as “processing”, “computing”, “calculating”, “determining”, “analysing” or the like, refer to the action and/or processes of a computer or computing system, or similar electronic computing device, that manipulate and/or transform data represented as physical, such as electronic, quantities into other data similarly represented as physical quantities.

### Processor

In a similar manner, the term “processor” may refer to any device or portion of a device that processes electronic data, e.g., from registers and/or memory to transform that electronic data into other electronic data that, e.g., may be stored in registers and/or memory. A “computer” or a “computing device” or a “computing machine” or a “computing platform” may include one or more processors.

The methodologies described herein are, in one embodiment, performable by one or more processors that accept computer-readable (also called machine-readable) code containing a set of instructions that when executed by one or more of the processors carry out at least one of the methods described herein. Any processor capable of executing a set of instructions (sequential or otherwise) that specify actions to be taken are included. Thus, one example is a typical processing system that includes one or more processors. The processing system further may include a memory subsystem including main RAM and/or a static RAM, and/or ROM.

### Computer-Readable Medium

Furthermore, a computer-readable carrier medium may form, or be included in a computer program product. A computer program product can be stored on a computer usable carrier medium, the computer program product comprising a computer readable program means for causing a processor to perform a method as described herein.

### Networked or Multiple Processors

In alternative embodiments, the one or more processors operate as a standalone device or may be connected, e.g., networked to other processor(s), in a networked deployment, the one or more processors may operate in the capacity of a server or a client machine in server-client network environment, or as a peer machine in a peer-to-peer or distributed network environment. The one or more processors may form a web appliance, a network router, switch or bridge, or any machine capable of executing a set of instructions (sequential or otherwise) that specify actions to be taken by that machine.

Note that while some diagram(s) only show(s) a single processor and a single memory that carries the computer-readable code, those in the art will understand that many of the components described above are included, but not explicitly shown or described in order not to obscure the inventive aspect. For example, while only a single machine is illustrated, the term “machine” shall also be taken to include any collection of machines that individually or jointly execute a set (or multiple sets) of instructions to perform any one or more of the methodologies discussed herein.

### Additional Embodiments

Thus, one embodiment of each of the methods described herein is in the form of a computer-readable carrier medium carrying a set of instructions, e.g., a computer program that are for execution on one or more processors. Thus, as will be appreciated by those skilled in the art, embodiments of the present invention may be embodied as a method, an apparatus such as a special purpose apparatus, an apparatus such as a data processing system, or a computer-readable carrier medium. The computer-readable carrier medium carries computer readable code including a set of instructions that when executed on one or more processors cause a processor or processors to implement a method. Accordingly, aspects of the present invention may take the form of a method, an entirely hardware embodiment, an entirely software embodiment or an embodiment combining software and hardware aspects. Furthermore, the present invention may take the form of carrier medium (e.g., a computer program product on a computer-readable storage medium) carrying computer-readable program code embodied in the medium.

### Carrier Medium

The software may further be transmitted or received over a network via a network interface device. While the carrier medium is shown in an example embodiment to be a single medium, the term “carrier medium” should be taken to include a single medium or multiple media (e.g., a centralized or distributed database, and/or associated caches and servers) that store the one or more sets of instructions. The term “carrier medium” shall also be taken to include any medium that is capable of storing, encoding or carrying a set of instructions for execution by one or more of the processors and that cause the one or more processors to perform any one or more of the methodologies of the present invention. A carrier medium may take many forms, including but not limited to, non-volatile media, volatile media, and transmission media.

### Implementation

It will be understood that the steps of methods discussed are performed in one embodiment by an appropriate processor (or processors) of a processing (i.e., computer) system executing instructions (computer-readable code) stored in storage. It will also be understood that the invention is not limited to any particular implementation or programming technique and that the invention may be implemented using any appropriate techniques for implementing the functionality described herein. The invention is not limited to any particular programming language or operating system.

### Means For Carrying out a Method or Function

Furthermore, some of the embodiments are described herein as a method or combination of elements of a method that can be implemented by a processor of a processor device, computer system, or by other means of carrying out the function. Thus, a processor with the necessary instructions for carrying out such a method or element of a method forms a means for carrying out the method or element of a method. Furthermore, an element described herein of an apparatus embodiment is an example of a means for carrying out the function performed by the element for the purpose of carrying out the invention.

### Connected

Similarly, it is to be noticed that the term connected, when used in the claims, should not be interpreted as being limitative to direct connections only. Thus, the scope of the expression a device A connected to a device B should not be limited to devices or systems wherein an output of device A is directly connected to an input of device B. It means that there exists a path between an output of A and an input of B which may be a path including other devices or means. “Connected” may mean that two or more elements are either in direct physical or electrical contact, or that two or more elements are not in direct contact with each other but yet still co-operate or interact with each other.

### Embodiments

Reference throughout this specification to “one embodiment” or “an embodiment” means that a particular feature, structure or characteristic described in connection with the embodiment is included in at least one embodiment of the present invention. Thus, appearances of the phrases “in one embodiment” or “in an embodiment” in various places throughout this specification are not necessarily all referring to the same embodiment, but may.

Furthermore, the particular features, structures or characteristics may be combined in any suitable manner, as would be apparent to one of ordinary skill in the art from this disclosure, in one or more embodiments.

Similarly it should be appreciated that in the above description of example embodiments of the invention, various features of the invention are sometimes grouped together in a single embodiment, figure, or description thereof for the purpose of streamlining the disclosure and aiding in the understanding of one or more of the various inventive aspects. This method of disclosure, however, is not to be interpreted as reflecting an intention that the claimed invention requires more features than are expressly recited in each claim. Rather, as the following claims reflect, inventive aspects lie in less than all features of a single foregoing disclosed embodiment. Thus, the claims following the Detailed Description of Specific Embodiments are hereby expressly incorporated into this Detailed Description of Specific Embodiments, with each claim standing on its own as a separate embodiment of this invention.

Furthermore, while some embodiments described herein include some but not other features included in other embodiments, combinations of features of different embodiments are meant to be within the scope of the invention, and form different embodiments, as would be understood by those in the art. For example, in the following claims, any of the claimed embodiments can be used in any combination.

### Specific Details

In the description provided herein, numerous specific details are set forth. However, it is understood that embodiments of the invention may be practiced without these specific details. In other instances, well-known methods, structures and techniques have not been shown in detail in order not to obscure an understanding of this description.

### Terminology

In describing the preferred embodiment of the invention illustrated in the drawings, specific terminology will be resorted to for the sake of clarity. However, the invention is not intended to be limited to the specific terms so selected, and it is to be understood that each specific term includes all technical equivalents which operate in a similar manner to accomplish a similar technical purpose. Terms such as “forward”, “rearward”, “radially”, “peripherally”, “upwardly”, “downwardly”, and the like are used as words of convenience to provide reference points and are not to be construed as limiting terms.

### Different Instances of Objects

As used herein, unless otherwise specified the use of the ordinal adjectives “first”, “second”, “third”, etc., to describe a common object, merely indicate that different instances of like objects are being referred to, and are not intended to imply that the objects so described must be in a given sequence, either temporally, spatially, in ranking, or in any other manner.

### Comprising and Including

In the claims which follow and in the preceding description of the invention, except where the context requires otherwise due to express language or necessary implication, the word “comprise” or variations such as “comprises” or “comprising” are used in an inclusive sense, i.e. to specify the presence of the stated features but not to preclude the presence or addition of further features in various embodiments of the invention.

Any one of the terms: including or which includes or that includes as used herein is also an open term that also means including at least the elements/features that follow the term, but not excluding others. Thus, including is synonymous with and means comprising.

### Scope of Invention

Thus, while there has been described what are believed to be the preferred embodiments of the invention, those skilled in the art will recognize that other and further modifications may be made thereto without departing from the spirit of the invention, and it is intended to claim all such changes and modifications as fall within the scope of the invention. For example, any formulas given above are merely representative of procedures that may be used. Functionality may be added or deleted from the block diagrams and operations may be interchanged among functional blocks. Steps may be added or deleted to methods described within the scope of the present invention.

Although the invention has been described with reference to specific examples, it will be appreciated by those skilled in the art that the invention may be embodied in many other forms.

### INDUSTRIAL APPLICABILITY

It is apparent from the above, that the arrangements described are applicable to the security industry.

The claims defining the invention are as follows:

1. A computing device for authentication, the computing device comprising:
a processor for processing digital data;
a memory device for storing digital data including computer program code and being coupled to the processor; and
an interface for sending and receiving digital data and being coupled to the processor, wherein the processor is controlled by the computer program code to:
receive, via the interface, image selection data representing an image selection from a set of candidate images; and
authenticate in accordance with the image selection data.

2. A computing device as claimed in claim 1, wherein, in authenticating, the processor is further controlled by the computer program code to compare the image selection data against authentication image data representing an authentication image.

3. A computing device as claimed in claim 2, wherein the processor is further controlled by the computer program code to calculate session data representing a session, and associate the authentication image data with the session data.

4. A computing device as claimed in claim 3, wherein the processor is further controlled by the computer program code to:
receive, via the interface, credential data representing login credentials; and
calculate the session data in accordance with the login credentials.

5. A computing device as claimed in claim 1, wherein, the processor is further controlled by the computer program code to select candidates image data representing the set of candidate images from superset image data representing a superset of images.

6. A computing device as claimed in claim 5, wherein the candidate image data is collected in a pseudorandom manner.

7. A computing device as claimed in claim 1, wherein the processor is further controlled by the computer program code to:
receive, via the interface, further image selection data representing a further image selection from the set of images; and
authenticate further in accordance with the further image selection data.

8. A computing device as claimed in claim 7, wherein the processor is further controlled by the computer program code to calculate session data representing a session, and authenticate further in accordance with the session data.

9. A computing device as claimed in claim 1, wherein, the processor is further controlled by the computer program code to:
receive, via the interface, zone association data representing an association of the image selection with a zone; and
authenticate further in accordance with the zone association data.

10. A computing device as claimed in claim 1, wherein, the processor is further controlled by the computer program code to recognise a gesture.

11. A computing device as claimed in claim 10, wherein the gesture is a drag and drop gesture.

12. A computing device as claimed in claim 10, wherein the gesture is a swipe gesture.

13. A computing device as claimed in claim 1, further comprising a display device for displaying information, the display device being coupled to the processor, and wherein the processor is further controlled by the computer program code to display, using the display device, the set of candidate images.

14. A computing device as claimed in claim 13, wherein the processor is further controlled by the computer program code to display, using the display device, the set of candidate images in grid format.

15. A computing device as claimed in claim 14, wherein the processor is further controlled by the computer program code to display, using the display device, the set of candidate images in pseudorandom order.

16. A computing device as claimed in claim 13, wherein the processor is further controlled by the computer program code to display, using the display device, a set of zones.

17. A computing device as claimed in claim 16, wherein the processor is further controlled by the computer program code to display, using the display device, the set of zones pheripheral the candidate images.

18. A computing device for authentication, the computing device comprising:
a processor for processing digital data;
a memory device for storing digital data including computer program code and being coupled to the processor; and
an interface for sending and receiving digital data and being coupled to the processor, wherein the processor is controlled by the computer program code to:
receive, via the interface, image selection data representing an image selection from a set of candidate images;
select authentication image data representing an authentication image in accordance with session data representing a session; and
authenticate in accordance with a comparison of the image selection data and the authentication image data.
